(19) United States
(12) Patent Application Publication
(10) Pub. No.: US 2002/0088321 A1
(43) Pub. Date: Jul. 11, 2002

(54) Method and apparatus for perforating a non woven sheet

(76) Inventor: Galliano Boscolo, Vigliano Biellese (IT)

Correspondence Address: WEINGARTEN, SCHURGIN, GAGNEBIN & LEBOVICI LLP, TEN POST OFFICE SQUARE, BOSTON, MA, 02109, US

(21) Appl. No.: 09/902,529

(22) Filed: Jan. 31, 2002

(30) Foreign Application Priority Data
Jul. 12, 2000 (FR) 00 09114
Jul. 12, 2000 (FR) 00 09106

(51) Int. Cl. B26F 1/02

(52) U.S. Cl. 83/30; 83/670; 83/691

(57) ABSTRACT

To produce at least one perforation in a non-woven sheet (N) of fibers or filaments, said sheet (N) is brought into contact with a perforated cylinder (2), equipped with at least one insert (8). Each insert includes, at one end, a plane surface (S), and is provided with a recess (8b) which emerges in said plane surface (S), and which has a sharp edge (8g) formed by the intersection of the inner surface (8f) of said recess (8b) with said plane surface (S). A perforation in the non-woven sheet (N) is obtained by cutting out a portion (P) of the non-woven sheet (N) by shearing of the fibers or filaments of the non-woven sheet (N), between the sharp edge (8g) of said insert (8) and a perforating member (9) driven simultaneously in translation and in rotation about its own axis.

The present invention relates to the field of non-woven sheets, made of fibers or filaments, and intended, in particular, but not exclusively, for use in making sanitary articles, for example for disposable diapers for babies, for incontinent adults or for female sanitary protection. It relates, more especially, to a method for perforating a non-woven sheet and to an apparatus suitable for implementing this method.

There exist various methods for perforating non-woven sheets.

Document EP-A-0214608 describes a method for perforating a nonwoven fabric which comprises, specifically, thermoplastic fibers or filaments. This method consists in perforating the non-woven sheet by means of a plurality of needles which cooperate with a plurality of recesses. Through the action of the needles, the fibers of the non-woven sheet are pushed back locally and, in order to preserve the void thus formed, the studs and the contour of the recesses are heated so as to cause the thermoplastic fibers to melt. After the melted fibers have hardened, a perforation is obtained that has the shape of the needle and the contours of which are delimited and consolidated by fibers that have melted and are thus welded together.

This method has the drawback, on one hand, of necessitating the use of a non-woven fabric containing thermoplastic fibers and, on the other hand, of imparting a certain amount of rigidity to the non-woven fabric owing to the presence of the hardened areas on the periphery of the perforations.

Document EP-A-0974433 describes another type of method for perforating a non-woven sheet. According to this method, the sheet is pushed by a perforating member inside a through orifice provided in a thin part in such a way that the non-woven sheet projects from said hole. Cutting means positioned inside the thin part then cut the fibers projecting from said part so as to form perforations. The perforating member is a cylindrical stud the end of which is hemispherical, and which is designed to be driven simultaneously in translation along its longitudinal axis and in rotation about its own axis. The function of this perforating member is not to cut the fibers or the filaments of the sheet, this function being performed by the cutting members. This method necessitates a relatively complex device comprising, in particular, a hollow cylinder, the interior of which is equipped with cutting members and necessitates the use of a thin part in which the orifices are provided. In addition, this method does not guarantee that perforations having a sharp contour that is reproducible in time will be obtained.

The object of the present invention is to provided a novel method for perforating a non-woven sheet of fibers or of filaments that remedies, in particular, wholly or in part, the drawbacks associated with the use of the methods of the prior art.

The method according to the invention is known, in particular, from patent application EP-A-0974433, in that the non-woven sheet is brought into contact with a perforated cylinder, and at least one perforation is made in the sheet by means of at least one perforating member, which is driven simultaneously in translation and in rotation about its own axis.

In a manner characteristic of the invention, there is previously fixed on the perforated cylinder at least one insert, including at one end a plane surface, and provided with a recess that emerges in said plane surface, and which has a sharp edge formed by the intersection of the inner surface of said recess with said plane surface; a perforation in the non-woven sheet is obtained by cutting out a portion of the non-woven sheet by shearing the fibers or filaments of the non-woven sheet, between the sharp edge of said insert and a perforating member driven simultaneously in translation and in rotation about its axis.

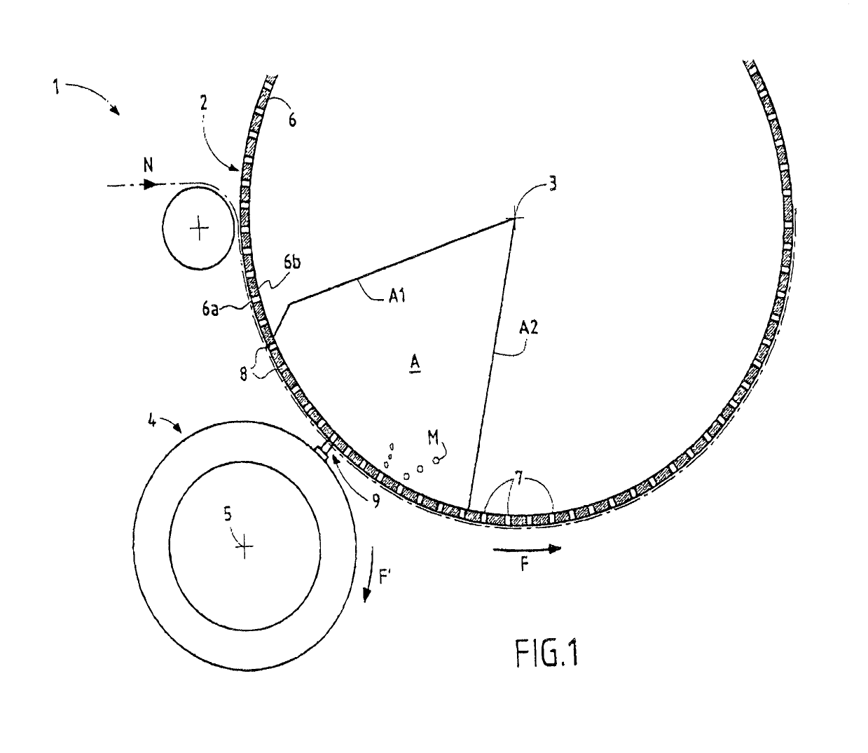

The Applicant has demonstrated that the fact of implementing a sharp edge formed in a plane (plane end surface of the insert), in combination with a perforating member driven in rotation about its own axis, advantageously enables the fibers or filaments of the non-woven sheet to be cut by shearing over the entire perimeter of the sharp edge, and thus enables perforations with sharp contours to be obtained. By way of comparison, in a device such as the one described in aforementioned European patent application EP-A-0974433, owing to the curvature of the outer face of the perforated cylinder (the face with which the sheet is brought into contact), the orifices of this cylinder in said outer surface are not perfectly plane. As a result, in practice, it is not possible, using the perforating members (studs) of this apparatus, to shear the fibers or filaments of the non-woven sheet over the entire periphery of said orifices. Thus, unlike the invention, in this prior art apparatus, a cutting member (reference number 16 in FIG. 1 of document EP-A-0974433) has to be provided inside the cylinder, which member makes it possible to cut the portions of sheet that are pushed back inside the perforated cylinder by the perforating members (studs).

The present invention also relates to an apparatus for perforating a non-woven sheet that enables the aforementioned perforating method of the invention to be implemented.

The present invention will be more readily understood, and its characteristics and advantages will emerge more clearly, on reading the description that follows and that refers to the annexed drawings showing a preferred form of embodiment of the apparatus of the present invention, presented by way of a non-limitative example, and wherein:

- FIG. 1 is a partial diagrammatic cross-sectional view of the preferred form of embodiment of the present invention;

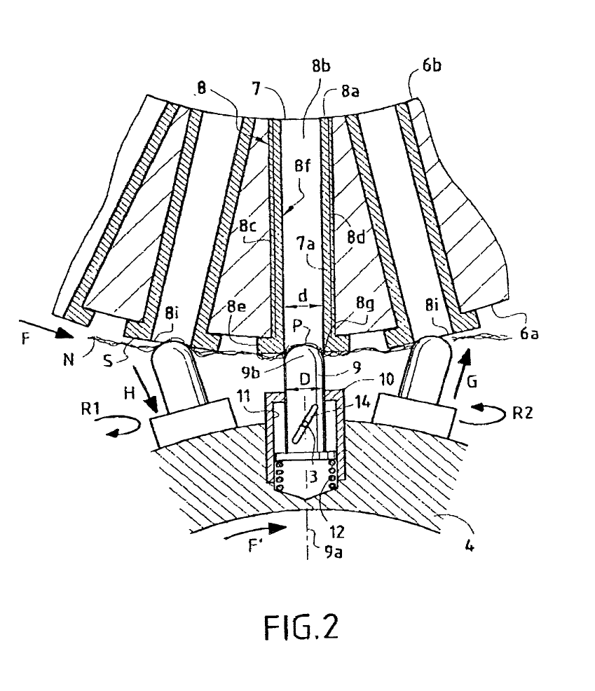

- FIG. 2 is an enlarged partial view of the apparatus of FIG. 1, in the area in which a stud cooperates with an orifice in the first cylinder with a view to perforating the non-woven sheet; and

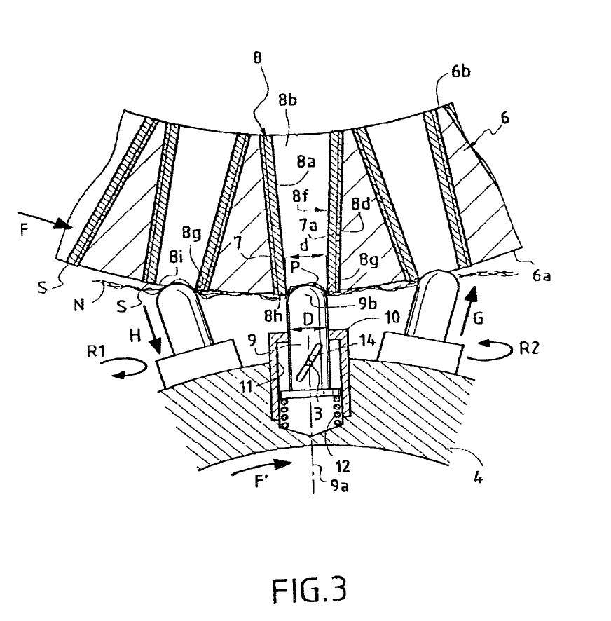

- FIG. 3 shows an alternative embodiment of the device according to the invention.

The preferred form of embodiment of the apparatus according to the present invention will now be described with reference to FIG. 1.

Apparatus 1, designed for perforating a non-woven sheet, comprises a first cylinder 2 which is a perforated cylinder. This cylinder 2 is driven in rotation (arrow F) about its longitudinal axis 3. Apparatus 1 also comprises a second cylinder 4 driven in rotation (arrow F′) about its longitudinal axis 5 parallel to axis 3 of first cylinder 2.

First, perforated cylinder 2 comprises on its external periphery a cylindrical piece 6 provided with a plurality of through perforations 7. These perforations 7 are aligned with the axis of the cylinder in the form of parallel rows distributed over the entire periphery of the cylinder. Each perforation 7 is equipped with a removable insert 8, which will be described in greater detail with reference to FIG. 2. In another alternative embodiment, piece 6 could be dispensed with and directly replaced by the perforated wall of cylinder 2.

Second cylinder 4 is equipped on its periphery with studs 9, which are arranged to cooperate with inserts 8 of perforations 7 provided in external piece 6 of first cylinder 2. In the preferred form of embodiment shown here, cylinder 2 also comprises a fixed suction area A which is delimited by walls Al and A2, and which enables sheet N to be pressed by suction against first face 6a of piece 6 and enables the pieces M of the sheet that have been cut out to be discharged.

With reference to FIG. 2, each insert 8 includes a body 8a provided with a recess (or perforation) 8b having a circular cross-section. This recess 8b is a through orifice in the example shown, but it could also, according to the invention, have a bottom, at the opposite end from its external orifice 8i . Outer surface 8c of body 8a is equipped with a thread 8d which engages with a reverse thread 7a provided inside each perforation 7 in order to fix each insert 8 in a perforation 7. Body 8a comprises, at one of its ends, a flange 8e having a plane outer surface (S), in which emerges recess 8b (orifice 8i +L). Plane surface (S) of flange 8e forms, with the inner surface 8f of recess 8b , a sharp edge 8g. Flange 8e can advantageously serve as a gripping means for fixing inserts 8 in, or removing them from, perforations 7.

In one alternative embodiment shown in FIG. 3, insert 8 does not have a flange 8e and recess 8b emerges in the area of a plane end 8h of the insert. Such an insert does have a sharp edge 8g +L, formed by the intersection of the inner surface 8f of recess 8b with end 8h of the insert 8, which end 8h forms a plane surface (S), which corresponds to the thickness of body 8a +L. In this variant, the diameter of perforations 7 increases from first face 6a of piece 6 towards second face 6b of the latter; the diameter of the recess of each insert 8 increases starting from sharp edge 8g +L. The flared shape of recess 8 resulting therefrom facilitates the removal of pieces M from recesses 8b . This additional characteristic can also be applied to a variant having inserts equipped with flanges, of the type shown in FIG. 2.

In one alternative embodiment of the means for cutting the non-woven sheet shown in FIG. 2, stud 9 is mounted in an external piece 10 of the second cylinder 4 via a housing 11 at the bottom of which is placed a spring 12. Stud 9 is a cylinder having an axis 9a which is arranged in housing 11 in such a way as to rotate about its own axis (about its axis 9a) when it moves in the direction of arrow H (that is to say in a direction parallel to its axis of rotation and in the opposite direction from perforated cylinder 2). More precisely, stud 9 is provided with a pin 13 projecting inside housing 11, with said pin penetrating a slideway 14 which is formed in the wall of housing 11 and which is inclined in relation to direction H of translation movement of stud 9.

When stud 9 moves in translation, pin 13 moves correlatively along slideway 14. Owing to the inclination of slideway 14, stud 9 rotates slightly about its own axis in a first direction of rotation R1 when it moves in translation in direction H, and in a second direction of rotation R2 when it moves in direction G opposite to direction H, that is to say in the direction of perforated cylinder 2. In this preferred form of embodiment, thread 8d equipping each of inserts 8 is such that rotational movement in direction R1 of studs 9 more tightly secures each of inserts 8 in perforations 7.

Stud 9 has a rounded end 9b, of a hemispherical type, and a diameter D slightly greater than diameter d of orifice 8i of recess 8b of insert 8, so as to be able to press sheet N between said hemispherical end 9b and sharp edge 8g of insert 8, which makes it possible to cut sheet N locally.

The operation of the device according to the invention will now be explained.

The two cylinders, 2 and 4, are driven in rotation (arrows F and F′/ FIGS. 2 and 3), being synchronized with one another such that hemispherical end 9b of a stud 9 is pressed precisely on sharp edge 8g of insert 8 with which it cooperates to produce a perforation locally in sheet N.

Owing to the rotation of cylinders 2 and 4, in a first stage, stud 9 comes into contact with insert 8 and is pushed back in contact with this insert 8 in direction H (left-hand stud in FIGS. 2 and 3), spring 12 being compressed. During this first translation movement in direction H, the stud is simultaneously driven in rotation in direction R1. When stud 9 and insert 8 are perfectly aligned (end of first stage/central stud in FIGS. 2 and 3), compression of the spring is at its maximum, and hemispherical end 9b of stud 9 is pressed perfectly against sharp edge 8g of insert 8. Then, in a second stage, owing to the rotation of the two cylinders, insert 8 and stud 9 leave their aligned position. In this second stage, the spring exerts on stud 9 a return force that enables it to be driven in translation in direction G, opposite from direction H. During this second translation movement in direction G, the stud is simultaneously driven in rotation in direction R2 opposite from R1 (second stage/right-hand stud in FIGS. 2 and 3).

During the aforementioned two stages, the end of stud 9 slightly penetrates housing 8b of corresponding insert 8, locally pushing back the portion (P) of the sheet located opposite said recess 8b, and presses said portion (P) of the sheet against sharp edge 8g. As the diameter D of the hemispherical end of a stud 9 is greater than the diameter d of recess 8b, and as edge 8g is located within a plane area (plane surface S of flange 8e or of end 8h of the insert), sheet N is thus locally compressed between sharp edge 8g and thus cut by shearing of the fibers or filaments going to make up sheet N, through the combined actions of rotation (in the two directions of rotation R1 and R2) of stud 9 and of pressure between said stud 9 and edge 8g.

According to the invention, it is important for each insert 8 to have a surface (S) that is plane. The Applicant has, in fact, demonstrated, without, however, being committed to this explanation, that, when the surface of flange 8e that comes into contact with sheet N is not rigorously plane, but is, for example, slightly curved as is, for example, the surface of perforated cylinder 2, it is not possible to obtain sufficient contact between the end of stud 9 and the totality of the perimeter of sharp edge 8g, so that it is not possible to press sheet N uniformly and sufficiently against sharp edge 8g of insert 8 to ensure that an entire portion (P) of sheet is cut off.

The invention advantageously makes it possible to produce in the non-woven sheet perforations that have a sharp, reproducible contour, without it being necessary to heat the filaments of the sheet. In particular, the invention advantageously enables perforations having a circular contour to be produced. Now, in the case of a hydrophobic non-woven sheet, such as that frequently used to produce sanitary articles, it is important for the perforations produced in said sheet to be circular. Only circular perforations in fact allow water or any other liquid to pass through the hydrophobic nonwoven fabric without wetting the surface of the latter, which makes it possible to absorb a liquid while having a dry surface.

More especially, the removable nature of the inserts advantageously enables the problems of wear of the inserts and, in particular, of their sharp edges 8g, to be overcome economically. When an insert 8 is worn, it suffices to replace it with a new one. The invention is not, however, limited to the use of inserts that are removable.

1. Method for perforating a non-woven sheet (N) of fibers or filaments, according to which said sheet (N) is brought into contact with a perforated cylinder (2), and at least one perforation is produced in the sheet (N) by means of at least one perforating member (9) that is driven simultaneously in translation and in rotation about its own axis, characterized, on one hand, in that there is previously fixed on the perforated cylinder (2) at least one insert (8), including, at one end, a plane surface (S), and provided with a recess (8b) that emerges in said plane surface (S), and which has a sharp edge (8g) formed by the intersection of the inner surface (8f) of said recess (8b) with said plane surface (S) and, on the other hand, in that a perforation in the non-woven sheet (N) is obtained by cutting out a portion (P) of the nonwoven sheet (N) by shearing of the fibers or filaments of the non-woven sheet (N), between the sharp edge (8g) of said insert (8) and a perforating member (9) driven simultaneously in translation and in rotation about its own axis.

2. Method according to claim 1, characterized in that, at the time of a perforating operation, said perforating member (9) is driven simultaneously in rotation in a first direction of rotation (R1) and in translation in a first direction (H) opposite from the perforated cylinder (2), and then is driven simultaneously in rotation in a second direction of rotation (R2) opposite from said first direction of rotation and in translation in the direction (G) opposite from the first direction of translation (H).

3. Method according to claim 1 or 2, characterized in that each insert (8) is removable.

4. Method according to claim 3, characterized in that each insert (8) is fixed by screwing onto the perforated cylinder (2).

5. Method according to claims 2 and 4, characterized in that the direction of screwing of each insert (8) corresponds to the first direction of rotation (R1) of a perforating member (9).

6. Method according to claim 1, characterized in that each insert (8) comprises a plane flange (8e).

7. Method according to claim 1, characterized in that the recess (8b) of an insert (8) has a diameter that increases starting from the sharp edge (8g).

8. Apparatus for perforating a non-woven sheet (N) of the type comprising a perforated cylinder (2) and at least one perforating member (9) which is capable of being driven simultaneously in translation and in rotation about its own axis, characterized in that the perforated cylinder (2) is equipped with at least one insert (8), including, at one end, a plane surface (S), and provided with a recess (8b) that emerges in said plane surface (S), and which has a sharp edge (8g) formed by the intersection of the inner surface (8f) of said recess (8b) with said plane surface (S), and in that the perforating tool (9) is capable of cooperating with said sharp edge (8g) so as to cut by shearing the fibers or filaments of the non-woven sheet (N), between the sharp edge (8g) of said insert (8) and said perforating member (9) driven simultaneously in translation and in rotation about its own axis.

9. Apparatus according to claim 8, characterized in that said perforating member (9) is designed to be driven in rotation in a first direction of rotation (R1) when it is moved in translation in a first direction (H) opposite from the perforated cylinder (2), and to be driven in rotation in a second direction of rotation (R2) opposite from said first direction of rotation during its movement in translation in the direction (G) opposite from the first direction of translation (H).

10. Apparatus according to claim 8 or 9, characterized in that each insert (8) is removable.

11. Apparatus according to claim 10, characterized in that each insert (8) is fixed by screwing onto the perforated cylinder (2).

12. Apparatus according to claims 9 and 11, characterized in that the direction of screwing of each insert (8) corresponds to the first direction of rotation (R1) of a perforating member (9).

13. Apparatus according to claim 8, characterized in that each insert (8) comprises a plane flange (8e).

14. Apparatus according to claim 1, characterized in that the recess (8b) of an insert (8) has a diameter that increases starting from the sharp edge (8g).
